(19) United States
(12) Patent Application Publication
(10) Pub. No.: US 2013/0320894 A1
(43) Pub. Date: Dec. 5, 2013

(54) PROTECTION CIRCUIT FOR A D.C. BRUSHLESS MOTOR PUMP

(71) Applicant: Hsia-Yuan HSU, Taichung (TW)

(72) Inventor: Hsia-Yuan HSU, Taichung (TW)

(21) Appl. No.: 13/962,126

(22) Filed: Aug. 8, 2013

Related U.S. Application Data
(63) Continuation-in-part of application No. 13/209,594, filed on Aug. 15, 2011.

(51) Int. Cl. H02P 6/00

(52) U.S. Cl. CPC H02P 6/001
USPC 318/400.21

(57) ABSTRACT

A protection circuit for a D.C. brushless motor pump in the present invention is to be installed on a driving circuit. The driving circuit is installed on a motor of the D.C. brushless motor pump. The motor consists of a rotor set and a stator set, while the protection circuit contains a micro-processing unit, a driving unit, a comparison unit and a signal source. The micro-processing unit is electrically connected with the driving unit, the comparison unit is electrically connected with the micro-processing unit while the signal source is electrically connected with the comparison unit. The signal source is a voltage signal produced by the motor itself when the rotor set is operated. The comparison unit can convert the signal source into a rotating speed value of the rotor set, and the micro-processing unit can function to supervise and control rotating speeds of the motor.

This application is a continuation in-part of U.S. patent application Ser. No. 13/209,594 filed on Aug. 15, 2011.

### BACKGROUND OF THE INVENTION

1. Field of the Invention This invention relates to a protection circuit, particularly to one applied to a D.C. brushless motor pump.

2. Description of the Prior Art

A pump is a mechanical device employed to increase pressure of liquid or gas for facilitating the liquid or the gas to be conveyed. A conventional pump includes a housing, a vane wheel and a motor. The housing is formed with an accommodating chamber in the interior and provided with thereon with a water intake and a water outlet, which communicate with the accommodating chamber. The vane wheel received in the accommodating chamber consists of a wheel body and a plurality of vanes annularly fixed around the circumferential side of the wheel body that has a central portion fixed with a rotating shaft by which the vane wheel can be operated together with the motor. When the pump is operated, liquid be will pumped to get into the accommodating chamber through the water intake, and the vane wheel will start rotating to have the vanes actuating the liquid to flow toward the water outlet. However, during operation of the pump, the liquid conveyed may contain impurities or unknown objects, which will flow into the pump together with the liquid to clog the water intake and make the liquid impossible to smoothly flow into the accommodating chamber. As a result, the pump may run idle to lose its function and the inner mechanism of the motor may be damaged due to excessively high temperature caused by idle running of the pump. Further, for purpose of controlling rotating speeds, the conventional pump has to be additionally installed inside with a water pressure sensor or a water flow sensor for detecting rotating speeds of the motor so as to control the motor to operate within a range of ideal rotating speeds, thus not only increasing manufacturing cost but also spoiling the structural strength of the pump. Furthermore, after used in water for a long period of time, the water pressure sensor is apt to produce aging and even cause trouble to affect operation of the pump.

### SUMMARY OF THE INVENTION

A first objective of this invention is to offer a protection circuit for a D.C. brushless motor pump, able to supervise and control the rotating speeds of the D.C. brushless motor of a pump to enable the motor to operate or stop operating within a range preset for protecting the structure of the D.C. brushless motor pump.

A second objective of this invention is to offer a protection circuit for a D.C. brushless motor pump, able to detect rotating speeds of the motor via a signal source (such as a Hall Effect IC, a counter electromotive force or a coder), which is produced by the motor itself when the rotor set is operated, needless to additionally install other electronic members like a water pressure sensor or a water flow sensor and thus able to reduce manufacturing cost of the D.C. brushless motor pump.

For attaining the purpose above mentioned, the protection circuit for a D.C. brushless motor pump in the present invention is installed on or connected to a driving circuit of the D.C. brushless motor of a pump. The motor contains a rotor set and a stator set, while the protection circuit consists of a micro-processing unit, a driving unit, a comparison unit and a signal source. The micro-processing unit is electrically connected with a control unit, which is able to control the micro-processing unit to transmit out a rotating speed control signal. The driving unit is electrically connected with the micro-processing unit for receiving the rotating speed control signal and driving the rotor set of the motor to rotate. The comparison unit preset with a rotating speed value of the rotor set is electrically connected with the micro-processing unit for changing the rotating speed control signal transmitted by the micro-processing unit. The signal source is electrically connected with the comparison unit, the signal source being a voltage signal produced by the motor itself when the rotor set is operated.

By so designing, when the rotor set is operated, the comparison unit can receive the signal source and, through logical operation, convert the signal source into a rotating speed value of the rotor set, which is then analyzed and collated with the rotating speed value preset by the comparison unit. Simultaneously, the micro-processing unit will function to supervise and control the rotating speeds of the motor to enable the motor to operate or stop operating within a range preset, thus attaining effect of protecting the structure of the D.C. brushless motor pump.

### BRIEF DESCRIPTION OF DRAWINGS

This invention will be better understood by referring to the accompanying drawings, wherein:

FIG. 1 is a circuit block diagram of a first preferred embodiment of a protection circuit for a D.C. brushless motor pump in the present invention;

FIG. 2 is a circuit diagram of the first preferred embodiment of the protection circuit for D.C. brushless motor pump in the present invention;

FIG. 3 is a schematic view of the first preferred embodiment of a protection circuit for a D.C. brushless motor pump in a using condition in the present invention; and

FIG. 4 is a circuit block diagram of a second preferred embodiment of the protection circuit for D.C. brushless motor pump in the present invention, and

FIG. 5 is a circuit diagram of the second preferred embodiment of the protection circuit for D.C. brushless motor pump in the present invention.

### DETAILED DESCRIPTION OF THE PREFERRED EMBODIMENT

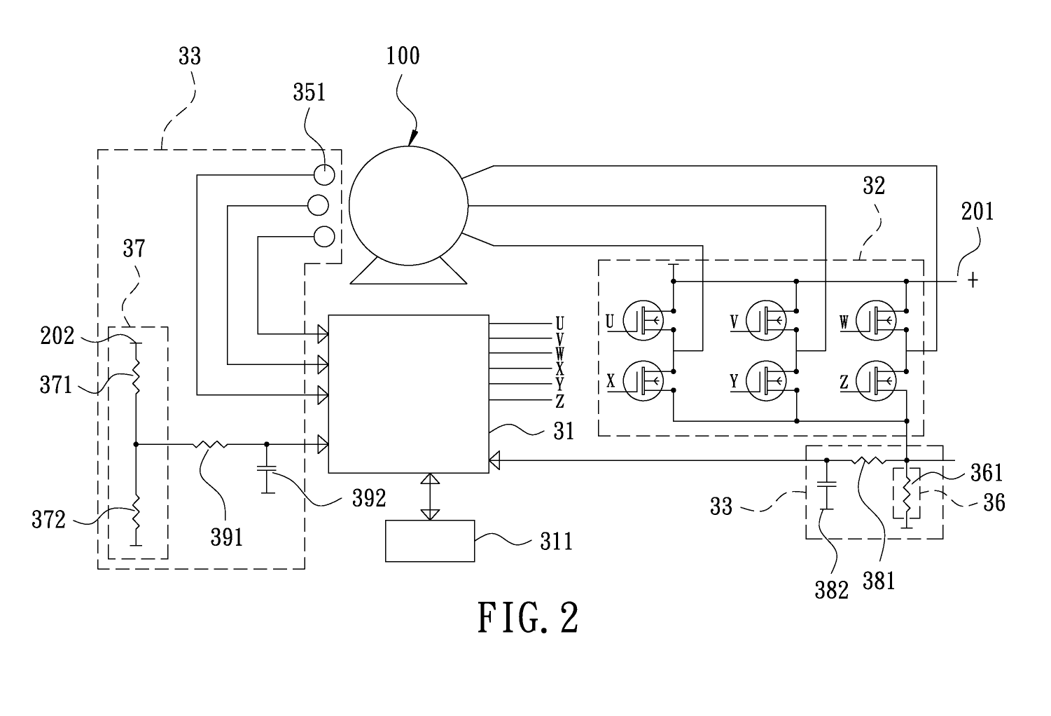

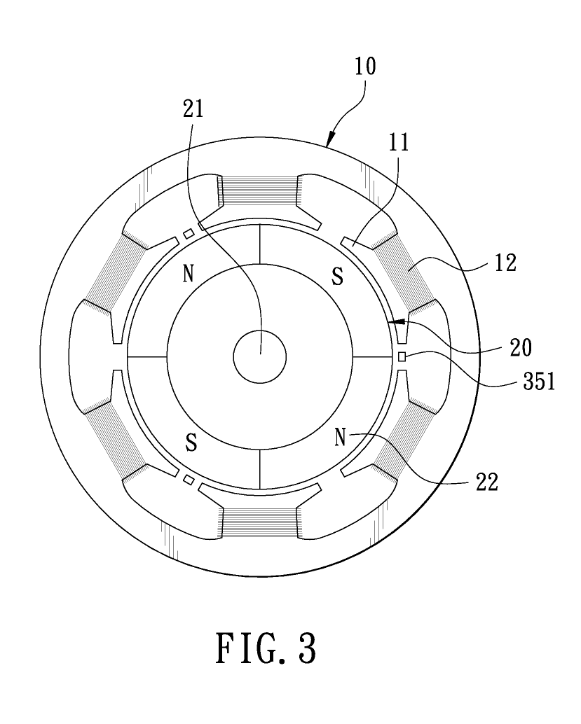

A protection circuit 30 for a D.C. brushless motor pump in the present invention is to be installed on or connected to a driving circuit 40. The driving circuit 40 is installed on a motor 100 of the D.C. brushless motor pump. The motor 100 is an inward turning three-phase D.C. brushless motor. The motor 100, as shown in FIGS. 2 and 3, mainly consists of a stator set 10 and a rotor set 20. The stator set 10 is an annular body surrounding the circumferential edge of the rotor set 20 and having the annular wall of its inner circumferential edge extended toward the center to form a plurality of magnetic permeating members 11 spaced apart equidistantly and respectively having an outer peripheral edge provided with lots of coils 12. The rotor set 20 has its center fixed with a rotating shaft 21 and its circumferential edge annularly disposed with a plurality of magnetic poles or permanent magnets.

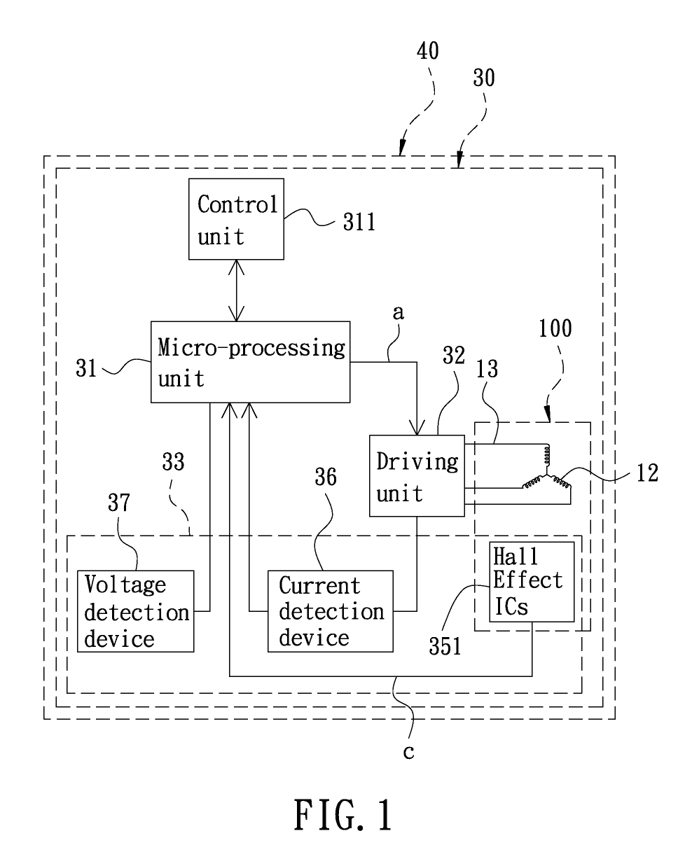

A first preferred embodiment of a protection circuit 30 for a D.C. brushless motor pump in the present invention, as shown in FIGS. 1-3, includes a micro-processing unit 31, a driving unit 32, a comparison unit 33 and a signal source 35 as main components electrically connected together.

The micro-processing unit 31 is electrically connected with a control unit 311 that can control the micro-processing unit 31 to transmit out a rotating speed control signal (a). In the preferred embodiment, the micro-processing unit 31 is a micro-processing IC while the control unit 311 is a micro-control module for controlling the micro-processing unit 31 to operate normally.

The driving unit 32 is electrically connected with the micro-processing unit 31 for receiving the rotating speed control signal (a) and, by means of a conductive wire set 13, transmitting direct current to the coils 12 on the magnetic permeating members 11 to make the coils 12 conduct electricity and generate magnetic fields for driving the rotor set 20 to rotate. In this preferred embodiment, the driving unit 32 is a power transistor able to decide flow quantity of D.C. to be output through change-over of the power transistor and electrically connected with a driving power source 201.

The comparison unit 33 electrically connected with the micro-processing unit 31, consisting of a current detection device 36, a voltage detection device 37 and three Hall Effect ICs 351. The current detection device 36 is electrically connected with the micro-processing unit 31 and the driving unit 32 and further electrically connected with the negative electricity circuit loop of the driving unit 32. The current detection device 36 contains a phase resistance 361, which is a micro ohm resistance, and the phase resistance 361 has one end electrically connected with both the driving unit 32 and the micro-processing unit 31 and another end electrically connected with an earth terminal for detecting load current. Further, a first resistance 381 is electrically connected between the phase resistance 361 and the micro-processing unit 31 and electrically connected with a first capacity 382, which has another end electrically connected with to an earth terminal to form a filter current. The voltage detection device 37 electrically connected with the micro-processing unit 31 is a divider resistance consisting of a second resistance 371 and a third resistance 372. The second resistance 371 has one end electrically connected with a driving power source 202 and another end electrically connected with the third resistance 372, which has another end electrically connected to an earth terminal for detecting operating voltage. Furthermore, a fourth resistance 391 is electrically connected between the voltage detection device 371 and the micro-processing unit 31, having one end electrically connected with both the second resistance 371 and the third resistance 372 and another end electrically connected with a second capacity 392, which has another end electrically connected to an earth terminal to make a filter circuit. The Hall Effect ICs 351 is combined with the stator set 10 for detecting change of magnetic flux passing through the Hall Effect ICs 351 when the rotor set 20 operates in unit time to obtain a signal of rotating speeds.

To start the motor 100 to operate, referring to FIGS. 1 and 3, the micro-processing unit 31 is started and controlled by the control unit 311 to operate and transmit a rotating speed control signal (a) to the driving unit 32 that enables the magnetic permeating members 11 of the stator set 10 to generate magnetic fields, and simultaneously the magnetic permeating members 11 will be actuated to rotate by repulsive force provided between the magnetic fields of the magnetic permeating members 11 and the permanent magnets 22 of the rotor set 20. Further, the driving unit 32 can control and convert the magnetic fields of the magnetic permeating members 11 into the same magnetic pole as that of the permanent magnets 22 of the rotor set 20 to let the rotor set 20 rotate successively in a same direction. Nevertheless, when the pump is operated, impurities or unknown objects are apt to clog the water intake of the pump and as a result, water cannot steadily flow into the pump and thus, the pump may run idle and become damaged.

Therefore, the protection circuit for a D.C. brushless motor pump in the present invention can function to supervise and control the rotating speeds of the motor 100 to judge whether or not the motor 100 is operated normally. When the rotor set 20 is rotated, the Hall Effect ICS 351 will obtain a voltage signal (c). In this preferred embodiment, the Hall Effect ICs 351 are respectively installed in the gaps of the stator set 10 and positioned spaced apart equidistantly, able to sense change of magnetic flux (density of magnetic fields) passing through the Hall Effect ICs 351 when the rotor set 20 operates in unit time and obtain the voltage signal (c) to be transmitted to the micro-processing unit 31. After the micro-processing unit 31 has the voltage signal (c) logically operated and converts the voltage signal (c) into a rotating speed value of the rotor set 20, the rotating speed value of the rotor set 20 will be analyzed and compared with the load current and the operating voltage respectively detected by the current detection device 36 and the voltage detection device 37 to enable the micro-processing unit 31 to carry out supervisory control of the rotating speeds of the motor 100. In this preferred embodiment, when the rotating speed of the rotor set 20 is higher than the rotating speed value preset, it means that the rotating speed of the motor 100 is too high, or the motor 100 may run idle and as a result, the motor 100 and other accessories are likely to be damaged because the motor is operated at high speeds for a long time and produces excessively high temperature. At this time, the comparison unit 33 will function to analyze and compare the load current and the operating voltage value respectively detected by the current detection device 36 and the voltage detection device 37 and output a feedback signal to the micro-processing unit 31 to have the micro-processing unit 31 giving out a control signal (a) of slowing down rotating speeds to enable the driving unit 32 to reduce the D.C, current flowing through the coil 12 for lowing the rotating speeds of the rotor set 20. Or the driving unit 32 can directly cut off the power of the coil 12 to let the motor 100 stop operating to prevent the motor 100 from producing excessively high temperature and causing damage. By so designing, the protection circuit 30 of this invention has effects of supervising and controlling the rotating speeds of the motor 100 to let the rotating speeds of the motor 100 maintain the best working rotating speeds to operate or stop operating for protection of the pump structure.

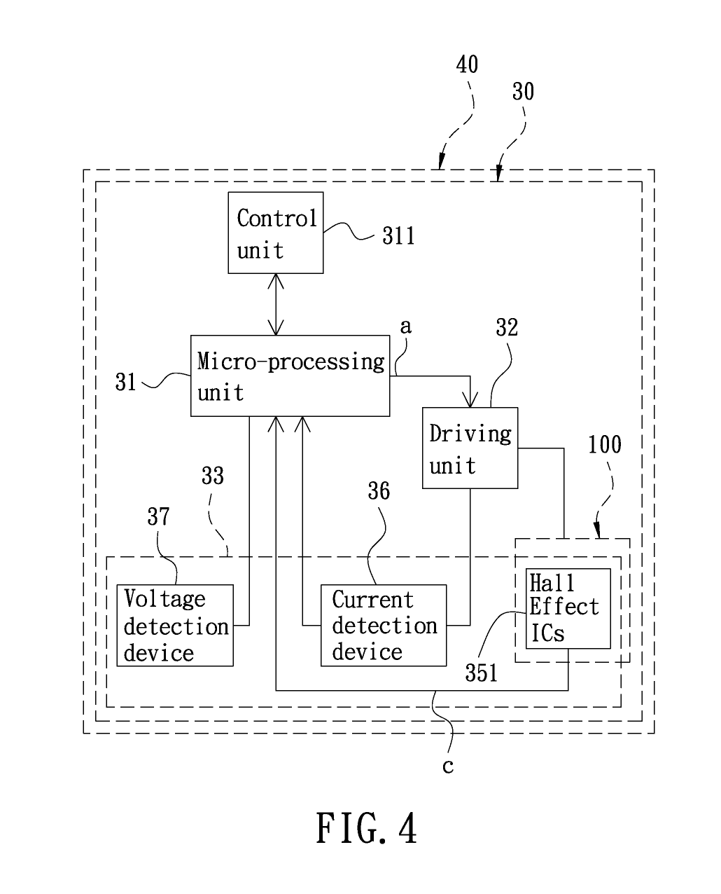

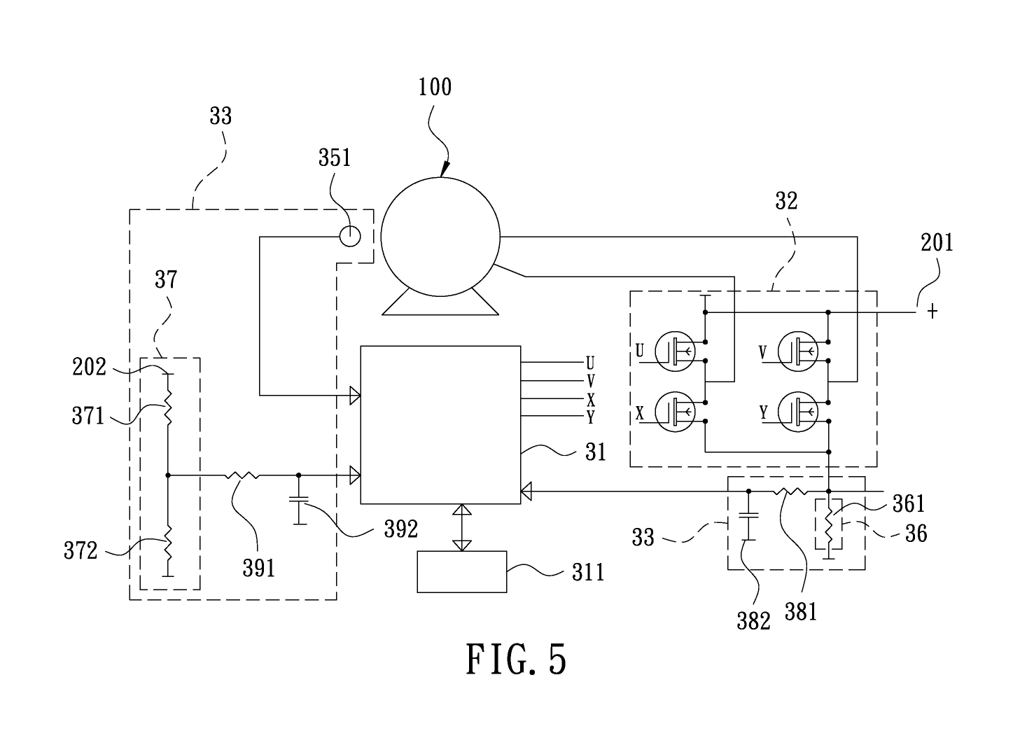

A second preferred embodiment of a protection circuit for a D.C. brushless motor pump in the present invention, as shown in FIGS. 4 and 5, has almost the same structure as that of the first preferred embodiment, except that the protection circuit 30 is installed with the driving circuit 40 of an inward turning type single-phase motor 100 of the pump. Thus, the Hall Effect ICs 351 can produce a voltage signal (c) and have the voltage signal (c) transmitted to the micro-processing unit 31 to be logically operated and converted into the rotating speed value of the rotor set 20. Simultaneously, the micro-processing unit 31 has the rotating speed value of the rotor set 20 analyzed and compared with a preset rotating speed value of the load current and the operating voltage value that are respectively detected by the current detection device 36 and the voltage detection device 37 and the carry out rotating speed supervisory control to the motor 100, equally attaining the objective of protection of the pump structure.

The special features and the advantages of the protection circuit of this invention are described as follows.

1. Through logical operation, the voltage signal obtained by the variation of magnetic flux of the Hall Effect ICs can be converted into a rotating speed value of the rotor set, which is the analyzed and collated with the preset rotating speed value gained by the load current and the operating voltage value respectively detected by the current detection device and the voltage detection device. Then, the micro-processing unit will carry out supervisory control to the rotating speeds to the motor to let the motor kept in a preset range to operate or stop operating, thus achieving the objective of protection of the pump structure.

2. In the present invention, the Hall Effect IC can be employed for detecting the rotating speeds of the motor, and it is needless to have the protection circuit installed with unnecessary electronic members like a water pressure sensor or a water flow sensor, able to reduce manufacturing cost of the pump.

While the preferred embodiments of the invention have been described above, it will be recognized and understood that various modifications may be made therein and the appended claims are intended to cover all such modifications that may fall within the spirit and scope of the invention.

What is claimed is:

1. A protection circuit for a D.C. brushless motor pump being installed on or connected to a driving circuit, said driving circuit installed on a motor of said D.C. brushless motor pump, said motor composed of a rotor set and a stator set, said protection circuit comprising:
a micro-processing unit electrically connected with a control unit, said control unit controlling said micro-processing unit to transmit out a rotating speed control signal;
a driving unit electrically connected with said micro-processing unit, said driving unit receiving said rotating speed control signal and driving said rotor set of said motor to rotate;
a comparison unit containing a current detection device, a voltage detection device and at least one Hall Effect IC, said current detection device electrically connected with said micro-processing unit and said driving unit for detecting load current, said voltage detection device electrically connected with said micro-processing unit for detecting operating voltage, said Hall Effect IC combined with said stator set of said motor, said Hall Effect IC able to detect variation of magnetic flux passing through said Hall Effect IC when said rotor set operates in unit time and obtain a rotating speed signal; and
said rotor set rotated, a voltage signal obtained via variation of magnetic flux of said Hall Effect IC, said voltage signal logically operated and converted into a rotating speed value of said rotor set, said rotating speed value of said rotor set analyzed and collated with said load current and said operating voltage respectively detected by said current detection device and said voltage detection device, said micro-processing unit carrying out rotating speed supervisory control to said motor to achieve an objective of protection of said pump structure.

2. The protection circuit for a D.C. brushless motor pump as claimed in claim 1, wherein said driving unit has at least one conducting wire transmitting an electric current to one of the coils of said motor to make said coil electrically conducted and general a magnetic field for driving said motor to rotate.

3. The protection circuit for a D.C. brushless motor pump as claimed in claim 1, wherein said current detection device consisting of a phase resistance, said phase resistance having one end electrically connected with said driving unit and said micro-processing and another end electrically connected to an earth terminal.

4. The protection circuit for a D.C. brushless motor pump as claimed in claim 3, wherein a first resistance is electrically connected between said phase resistance and said micro-processing unit and another end electrically connected to an earth terminal to form a filter circuit.

5. The protection circuit for a D.C. brushless motor pump as claimed in claim 3, wherein said phase resistance is a micro ohm resistance.

6. The protection circuit for a D.C. brushless motor pump as claimed in claim 1, wherein said driving unit is electrically connected with a driving power source while said current detection device is electrically connected with negative electricity circuit loop of said driving unit.

7. The protection circuit for a D.C. brushless motor pump as claimed in claim 1, wherein said voltage detection device is composed of a second resistance and a third resistance, said second resistance having one end electrically connected with a driving power source and another end electrically connected with said third resistance and said micro-processing unit, said third resistance having another end electrically connected to an earth terminal.

8. The protection circuit for a D.C. brushless motor pump as claimed in claim 7, wherein a fourth resistance is electrically connected between said voltage detection device and said micro-processing unit, said fourth resistance having one end electrically connected with said second resistance and said third resistance, said fourth resistance having another end electrically connected with a second capacity, said second capacity having another end electrically connected to an earth terminal.
